(19) United States
(12) Patent Application Publication
(10) Pub. No.: US 2026/0270058 A1
(43) Pub. Date: Sep. 10, 2026

(54) GENERATING SURROGATE IDENTIFIERS USING ENCRYPTED DATA

(71) Applicant: Google LLC, Mountain View, CA (US)

(72) Inventors: Chanda Rani Patel, Milpitas, CA (US); Yu Fan, South Pasadena, CA (US); Chun Heng Kok, Monterey Park, CA (US); Vamshi Reddy Konagari, Redmond, WA (US); Piyush Prakash, Los Angeles, CA (US)

(21) Appl. No.: 19/338,070

(22) Filed: Sep. 24, 2025

(30) Foreign Application Priority Data
Mar. 7, 2025 (IN) 202511020819

(51) Int. Cl. H04L 9/08

(52) U.S. Cl. CPC H04L 9/0877

(57) ABSTRACT

Methods, systems, and apparatus, including computer programs encoded on a computer storage medium, for generating surrogate user identifiers. In one aspect, a method includes receiving, by a surrogate identifier (ID) system, encrypted user data for a requesting entity. A surrogate ID generator running in a first trusted execution environment (TEE) of the surrogate ID system obtains, from multiple key coordinators, respective parts of a first key and respective parts of a second key. The first key is generated using the respective parts of the first key received from the multiple key coordinators. The second key is generated using the respective parts of the second key received from the multiple key coordinators. The surrogate ID generator decrypts the encrypted user data using the first key to obtain user data in cleartext. The surrogate ID generator generates a surrogate ID using the user data and the second key.

### CROSS-REFERENCE TO RELATED APPLICATION

This application claims priority to IN Provisional Application No. 202511020819, filed on Mar. 7, 2025. The disclosure of the prior application is considered part of and is incorporated by reference in the disclosure of this application.

### BACKGROUND

This specificationrelates to cryptography, data security, and data privacy.

User information is commonly provided to various online entities. For example, may users provide e-mail addresses and phone number to websites for use as contact information and/or login credentials. Such use of user information can enable entities to compile significant amounts of user information, which may be exposed to others on the Internet or used in malicious ways.

### SUMMARY

In general, one innovative aspect of the subject matter described in this specification can be embodied in methods that include the actions of receiving, by a surrogate identifier (ID) system, encrypted user data for a requesting entity; obtaining, by a surrogate ID generator running in a first trusted execution environment (TEE) of the surrogate ID system and from multiple key coordinators respective parts of a first key and respective parts of a second key; generating the first key using the respective parts of the first key received from the multiple key coordinators; generating the second key using the respective parts of the second key received from the multiple key coordinators; decrypting, by the surrogate ID generator, the encrypted user data using the first key to obtain user data in cleartext; generating, by the surrogate ID generator, a surrogate ID using the user data and the second key; and sending the surrogate ID to the requesting entity. Other implementations of this aspect include corresponding apparatus, systems, and computer programs, configured to perform the aspects of the methods, encoded on computer storage devices.

These and other embodiments can each optionally include one or more of the following features. In some aspects, each key coordinator comprises a respective second TEE for storing parts of keys.

In some aspects, the first key is a first private key, and the second key is a second private key. The encrypted user data can be generated by encrypting the user data using a first public key corresponding to the first private key.

In some aspects, generating, by the surrogate ID generator, the surrogate ID using the user data and the second key includes generating the surrogate ID based on the user data and additional data related to the requesting entity.

In some aspects, generating, by the surrogate ID generator, the surrogate ID using the user data and the second key includes applying a cryptographic hash function to the user data and the second key.

In some aspects, the surrogate ID system is operated by a first entity and each key coordinator is operated by a respective second entity different from each other and different from the first entity.

In some aspects, obtaining, by the surrogate ID generator running in the first TEE of the surrogate ID system and from multiple key coordinators respective parts of the first key and respective parts of the second key includes sending, to each key coordinator, a request comprising the binary of the surrogate ID generator and receiving, from each key coordinator, the respective part of the first key and the respective part of the second key of the key coordinator in response to the key coordinator verifying the binary.

In some aspects, the surrogate ID generator is stateless.

Particular embodiments of the subject matter described in this specification can be implemented so as to realize one or more of the following advantages. The techniques described in this document protect data security and enhance user privacy by generating and using surrogate identifiers that are based on encrypted user data such that the surrogate identifiers do not contain any actual information about the user. For example, a surrogate user identifier (“surrogate ID”) may be a hash value that includes what appears to be a random string of characters, e.g., letters, numbers, and/or symbols, rather than a username, e-mail address, phone number, or other user identifier. This prevents entities from associating actual users with data that is mapped to the surrogate IDs, while still enabling entities to use the data in meaningful ways. For example, an entity can correlate online events that involve a user using the surrogate IDs (e.g., based on event reports that include the surrogate ID) while not risking the privacy of the particular user represented by the surrogate ID.

The systems described herein are highly scalable and provide guarantees of distributed trust that end users have complete confidence that the user data can only be decrypted by the right entities and such that other entities cannot reverse engineer the surrogate ID process to generate the same surrogate IDs using the same encrypted user data. For example, a surrogate ID system can include a surrogate ID generator that runs in a trusted execution environment (TEE) and that generates surrogate IDs based on user data and using a cryptographic key, e.g., a private key, that is split between multiple key coordinators, e.g., multiple key management systems (KMSs). By splitting the key between multiple different entities and running the surrogate ID process in a TEE, no entity has access to the user data, or the entire key used to generate the surrogate IDs in cleartext. This distribution of the TEE and the split key among multiple key coordinators prevents entities from reverse engineering the surrogate ID logic, while also preventing entities from decrypting the encrypted user data (e.g., by not having the entire decryption key), absent unauthorized collusion between the operators of the key coordinators, which are trusted entities, and/or the surrogate ID system.

The system or components thereof can also be stateless, meaning that the system does not have to store all of the surrogate IDs generated by the system in memory. This significantly reduces the memory requirements of the TEE, which reduces the compute costs of the system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a surrogate ID system generates surrogate IDs for users.

FIG. 2 is a flow chart of an example process of generating a surrogate ID for a user.

FIG. 3 is a block diagram of an example computer.

Like reference numbers and designations in the various drawings indicate like elements.

### DETAILED DESCRIPTION

This document describes systems and techniques for generating surrogate IDs for use in place of actual user identifies in secure, scalable, and trustworthy manners. The surrogate IDs can include strings of characters, e.g., letters, numbers, and/or symbols, that appear to be random rather than a username, e-mail address, phone number, or other information that can identify a particular person. For example, each surrogate ID can be a hash value that is generated by applying a cryptographic hash function to user data and optionally to additional information.

The components of the overall environment for generating the surrogate IDs can be operated and/or managed by different entities such that no single entity can create the correct surrogate ID or a user individually. For example, the keys used to generate the surrogate IDs and the keys used to decrypt encrypted user data can be split between multiple key coordinators and a separate surrogate ID generator running in a TEE can combine the parts (e.g., splits) of the keys, use the keys to decrypt the encrypted user data, and generate the surrogate IDs using the decrypted user data and the keys. In this way, no entity has access to the assembled split keys or cleartext user data since these items are only available in the TEE that runs the surrogate ID generator. Cleartext is data that is unencrypted and easily readable. Cleartext is information transmitted or stored in its original, understandable form, without any form of scrambling or protection.

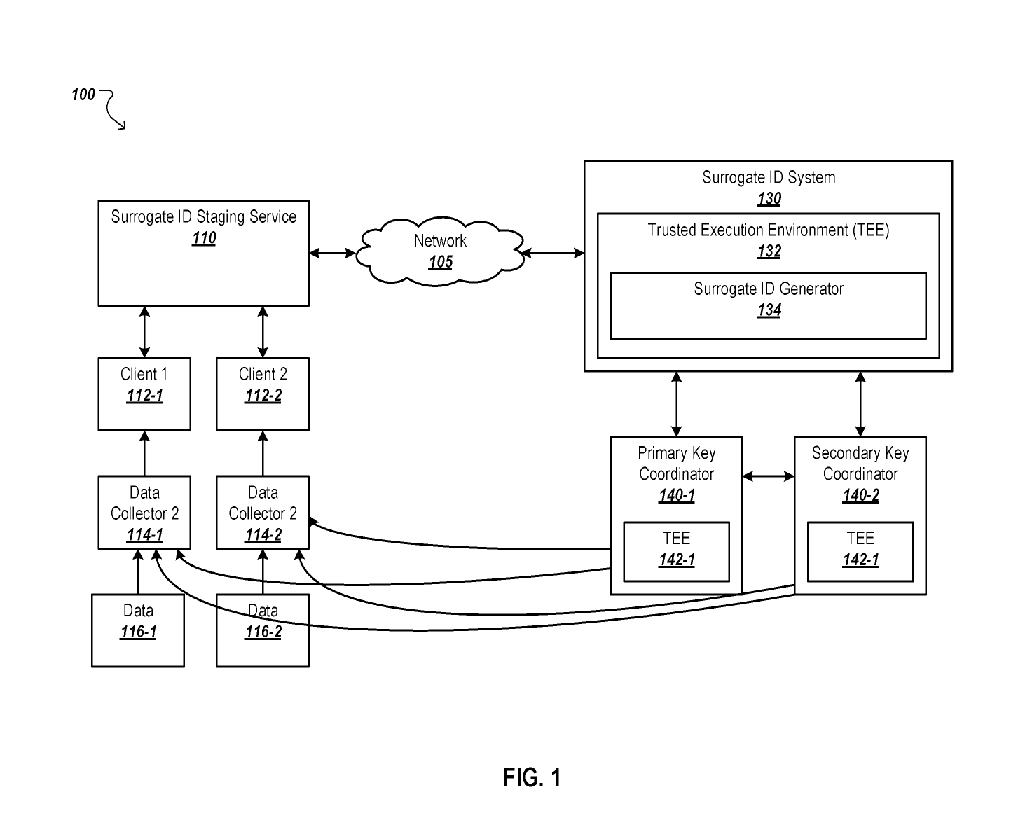

FIG. 1 is a block diagram of an example environment 100 in which a surrogate ID system 130 generates surrogate IDs for users. The example environment 100 includes a network 105, such as a local area network (LAN), a wide area network (WAN), the Internet, or a combination thereof. The network 105 connects the surrogate ID system 130 with a surrogate ID staging service 110, and optionally with key coordinators 140, e.g., key coordinators 140-1 and 140-2.

The surrogate ID system 130 is an example of a system implemented as computer programs on one or more computers in one or more locations, in which the systems, components, and techniques described below can be implemented. For example, the surrogate ID system 130 can be implemented in a cloud computing environment or as one or more on-location computers, e.g., server computers.

The surrogate ID system 130 is configured to generate surrogate IDs based on user data, e.g., user data received from the surrogate ID staging service 110 or directly from requesting entities such as client devices of users. The user data can include any type of data related to a user, e.g., data that can personally identify the user. For example, the user data can include a username, e-mail address, phone number, full name, residential address, and/or other appropriate data.

The surrogate ID system 130 includes a trusted execution environment (TEE) 132. The TEE 132 is a computing environment where the code that is executed and the data that is being accessed in the TEE 132 is isolated and protected in terms of confidentiality and integrity. The TEE 132 can be implemented using both computer hardware and software. For example, the TEE 132 can include a hardware isolation mechanism and software, e.g., an operating system, executing on the hardware isolation mechanism. The TEE 132 can be a secure area of a computer processor that guarantees the confidentiality and integrity of applications executing in the TEE 132 and data loaded in the TEE 132.

The surrogate ID system 130 includes a surrogate ID generator 134 that runs in the TEE 132. The surrogate ID generator 134 can include logic, e.g., in the form of code, that is executed in the TEE 132 for decrypting encrypted user data, combining parts of keys into their wholes to assemble the keys, and/or generating surrogate IDs using the decrypted user data and the assembled keys. The surrogate ID generator 134 can generate the surrogate IDs in response to requests received from the surrogate ID staging service 110 and return the surrogate IDs to the surrogate staging service 110, as described in more detail below.

The surrogate ID staging service 110, which can be implemented as computer programs on one or more computers in one or more locations, can request surrogate IDs from the surrogate ID generator 134 on behalf of clients 112, e.g., clients 112-1 and 112-2. The clients 112 can represent entities that use surrogate IDs to represent actual users but without using data that can personally identify the users. For example, an entity can be a publisher of a website. The publisher can use a surrogate ID to log events performed by a user at the website.

Another example entity is a digital component distribution system that distributes digital components to client devices of users. As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

The digital component distribution system can use the surrogate IDs to correlate events related to digital components with the users corresponding to the events. For example, when a digital component is presented to a user, a presentation event for the digital component can be logged with the surrogate ID for the user. Similarly, if the user interacts with the digital component, an interaction event for the digital component can be logged with the surrogate ID for the user. Additionally, if the user completes a specified action, e.g., acquires an item that is the subject of the digital component, a conversion event for the digital component can be logged with the surrogate ID for the user. The digital component distribution system can use these events in the log to correlate interaction and conversion events with presentation events for the digital component, e.g., to determine metrics such as click through rates and/or conversion rates for the digital components. Using the surrogate IDs in place of actual user identifiers can protect the security of the data and the privacy of the user data related to digital components viewed by, interacted with, and/or for which items were acquired by the users. For example, neither the digital component distribution system nor entities that are able to maliciously gain access to the system or the events reports being sent over the network 105 would be able to correlate the data with the actual users.

Further to the descriptions throughout this document, a user may be provided with controls (e.g., user interface elements with which a user can interact) allowing the user to make an election as to both if and when systems, programs, or features described herein may enable the collection of user information (e.g., information about a user’s social network, social actions, or activities, profession, a user’s preferences, or a user’s current location), and if the user is sent content or communications from a server. In addition, certain data may be treated in one or more ways before it is stored or used, so that personally identifiable information is removed. For example, a user’s identity may be treated so that no apparently personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

When an entity wants to obtain a surrogate ID for a user, the entity can send user data for the user to its client 112. This user data can be in cleartext. Before reaching the client 112, a data collector 114 can encrypt the user data using an encryption key, e.g., a public key. The data collector 114 can obtain the encryption key from one of the key coordinators 140. As described in more detail below, each key coordinator 140 can store keys in a TEE 142 and provide the keys to data collectors 114 and/or the surrogate ID system 130, e.g., to the surrogate ID generator 134. The key coordinators 140 can also store parts of split keys and provide the parts to the surrogate ID generator 134.

The data collector 114 can encrypt the user data using the encryption key and provide the encrypted user data to the client 112. In some implementations, a key coordinator 140 can encrypt the user data for the data collector. For example, the data collector 114 can send the user data to the key coordinator, e.g., with a request for encryption, and the key coordinator 140 can access the appropriate encryption key, encrypt the user data using the encryption key, and send the encrypted user data to the data collector 114.

In general, each client 112 can handle requests for surrogate IDs from one or more entities. For example, each entity can have a dedicated client that handles its requests for surrogate IDs, or a client 112 can be assigned to multiple entities. The clients 112 can be implemented as computer programs on one or more computers in one or more locations. For example, the clients 112 can be implemented in a cloud computing environment or as one or more on-location computers, e.g., server computers.

The clients 112 can send requests for surrogate IDs to the surrogate ID staging service 110. Each request can include encrypted user data for the user for which the surrogate ID is to be generated. Each request can also include an identifier for the entity for which the surrogate ID is to be generated. For example, the keys used to generate the surrogate IDs can be entity specific such that each entity has different keys. This identifier enables the surrogate ID generator 134 to request appropriate key parts from the key coordinators 140.

The surrogate ID staging service 110 interacts with the surrogate ID system 130 to obtain the surrogate IDs for the clients 112 to return to the requesting entities. The surrogate ID staging service 110 can manage a queue of requests and send the requests to the surrogate ID system 130 based on the queue. When the surrogate ID system 110 receives a surrogate ID from the surrogate ID system 130 in response to a request, the surrogate ID staging service 110 can provide the surrogate ID to the requesting client 112 which, in turn, can send the surrogate ID to the requesting entity.

The surrogate ID staging service 110, clients 112, and data collectors 114 are optional components. In other examples, requesting entities, e.g., publishers or digital component distribution systems, can request surrogate IDs directly from the surrogate ID system 130 by providing requests with encrypted user data to the surrogate ID system 130. In such examples, the requesting entity can perform the various operations of the surrogate ID staging service 110, clients 112, and/or data collectors 114.

As mentioned above, the surrogate ID generator 134 of the surrogate ID system 130 is configured to decrypt encrypted user data, combine parts of keys into their wholes to form assembled keys, and/or generate surrogate IDs using the decrypted user data and the assembled keys. When a request for a surrogate ID is received, the surrogate ID system 130 can request the appropriate key parts from the key coordinators 140. For example, the surrogate ID generator 134 can request parts of a first key from the key coordinators 140 to decrypt the encrypted user data of the request and parts of a second key from the key coordinators 140 to generate the surrogate ID. The first and second keys can be different private keys. For example, the first key can be a private key that corresponds to a public key used by a data collector 114 to encrypt the encrypted user data.

Each key coordinator 140 can be a different trusted party that maintain keys and/or parts of keys in its TEE 142 to prevent other entities from being able to obtain the key parts or can maintain the keys and/or key parts outside of the TEE 142. In implementations in which different keys are used for different requesting entities, each key coordinator 140 can maintain, for each requesting entity, an encryption key (e.g., public key) for encrypting user data for the entity, a part of a decryption key (e.g., private key) for decrypting the encrypted user data for the entity, and a part of a key (e.g., private key) for generating surrogate IDs for users associated with the entity. If the same keys are used for all requesting entities, each key coordinator 140 can maintain an encryption key (e.g., public key) for encrypting user data, a part of a decryption key (e.g., private key) for decrypting the encrypted user data, and a part of a key (e.g., private key) for generating surrogate IDs for users.

In some implementations, a key coordinator 140 can create a key and split the key into parts inside its TEE 142. For example, a key coordinator 140 can bit-split a key into key parts such that each private key is bit-split between multiple key coordinators 140. This ensures that no party can access any whole private key by acting alone. Importantly, the surrogate ID system 130 and the key coordinators 140 can be configured such that the parts of the keys are generated in a TEE, e.g., the TEE 142 of a key coordinator 140, and only assembled into their wholes within a TEE, e.g., the TEE 132 of the surrogate ID system 130. In addition, processes performed using the assembled keys may only be performed in a TEE, e.g., the TEE 132 of the surrogate ID system 130. This prevents the assembled keys from being accessible at any point outside of a TEE. For example, the logic used to cerate key parts and assemble the key parts may only be available inside of authorized TEEs 132 and 142.

In this example, there are two key coordinators 140-1 and 140-1. However, there can be more key coordinators in other implementations, e.g., in implementations in which each key is split into more than two parts. The parts of a key can be combined, e.g., assembled, to form a key that is used to decrypt encrypted user data or to generate a surrogate ID for a user. In this example, each key is split into two parts, one for key coordinator 140-1 and one for key coordinator 140-2. Example techniques for splitting keys between multiple key coordinators and combining the keys for use in encrypting and encrypting data are described in U.S. Patent Application No. 18/573,384, titled “SECURE ENVIRONMENT FOR OPERATIONS ON PRIVATE DATA,” filed on Feb. 15, 2023, which is incorporated herein by reference.

In some implementations, the key coordinators 140 are configured to evaluate the trustworthiness or integrity of the surrogate ID generator 134 prior to sending parts of keys to the surrogate ID generator 134. This ensures that the parts of the keys are not sent to a compromised device, a malicious emulator, or other malicious device.

For example, the surrogate ID generator 134 can send, with a request for parts of keys, the binary of the code of the surrogate ID generator 134 or data representing this binary, e.g., a hash value of the binary. The key coordinators 140 can verify this binary by comparing the binary to known trusted binaries for the surrogate ID generator 134. If there is a match, the key coordinator 140 can consider the surrogate ID generator 134 to be trustworthy and send the parts of the keys to the surrogate ID generator 134. If there is no match, the key coordinator 140 can consider the surrogate ID generator 134 to not be trustworthy and not send the parts of the keys to the surrogate ID generator 134. Example techniques for verifying an entity requesting split keys are described in U.S. Patent Application No. 18/573,384, titled “SECURE ENVIRONMENT FOR OPERATIONS ON PRIVATE DATA,” filed on Feb. 15, 2023, which is incorporated herein by reference.

When requesting parts of the first and second keys from the key coordinators 140, the surrogate ID generator 134 can also send the identifier for the requesting entity. This enables the key coordinators to obtain the parts of the first and second keys for the requesting entity.

If a key coordinator 140 determines that the surrogate ID generator 134 is trustworthy or otherwise determines to provide the parts of the first and second keys to the surrogate ID generator 134 in response to a request, the key coordinator can identify the part of the first key and the part of the second key for the requesting entity and send the two parts to the surrogate ID generator 134. Each other key coordinator can return its parts of the keys to the surrogate ID generator 134.

The surrogate ID generator 134 can receive the parts of the first and second keys from the key coordinator and combine the parts of each key to obtain the whole first key and the whole second key. For example, the surrogate ID generator 134 can combine the parts of the first key received from the key coordinators 140 to obtain the whole first key.

The surrogate ID generator 134 can decrypt the user data using the first key to obtain the user data in cleartext. The surrogate ID generator 134 can then generate the surrogate ID using the user data and the second key. In some implementations, the surrogate ID generator 134 generates the surrogate ID using a cryptographic hash function, e.g., by applying the cryptographic hash function to the user data in cleartext, the second key, and optionally additional data. The hash function can be, for example, a hash-based message authentication code (HMAC) function, e.g., HMAC-SHA256 or HMAC-SHA512.

The additional data can include data related to the requesting entity. In implementations in which the same keys are used for multiple requesting entities, the additional data ensures that the surrogate ID for the same user differs for the different requesting entities. The additional data for a requesting entity can include, for example, an identifier of the entity. In another example, the additional data can include a digital component provider identifier that identifies a provider of digital components. In this way, the surrogate ID for a user is different for different digital component providers.

After generating the surrogate ID, the surrogate ID generator 134 can return the surrogate ID to the requesting entity, e.g., either directly or via the surrogate ID staging service 110 and/or client 112. The entity can then use the surrogate ID in place of the actual user data for the user to protect the security of the user data and privacy of the user. For example, the entity can record events for the user with reference to the surrogate ID rather than the actual user ID for the user. The entity can then generate metrics related to events in ways that secure the actual data of the users and enhance user privacy. For example, if there is a data breach, the breaching entity would not gain access to user data if the breaching entity obtains the surrogate IDs and event data. The entities can also use the surrogate IDs to report events. For example, client device of a user can report events such as presentations of digital components or user interactions with digital components using the surrogate ID for the user rather than actual user information.

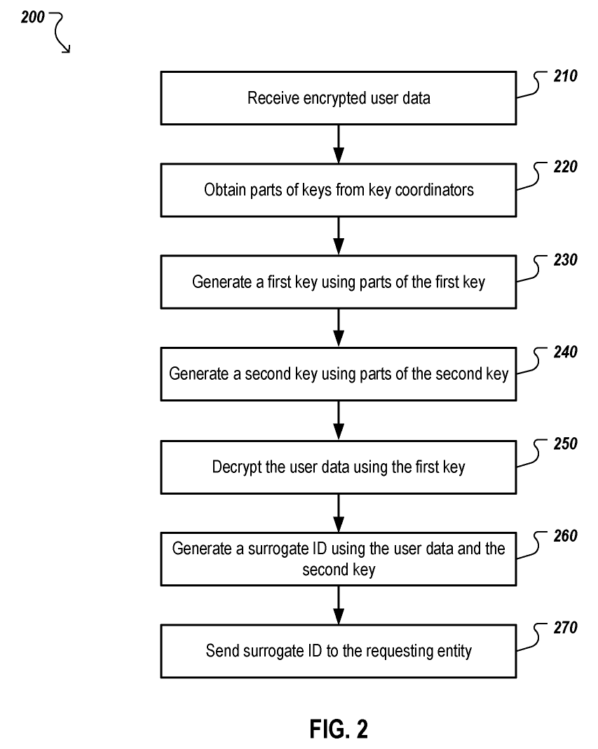

FIG. 2 is a flow chart of an example process 200 of generating a surrogate ID for a user. Operations of the process 200 can be performed, for example, by the surrogate ID system 130 of FIG. 1. The operations of the process 200 can also be implemented as instructions stored on a computer readable medium, which can be non-transitory. Execution of the instructions, by one or more data processing apparatus, causes the one or more data processing apparatus to perform operations of the process 200. For ease of subsequent description, the process 200 is described in terms of the surrogate ID system 130.

A surrogate ID generator 134 of the surrogate ID system 130 receives encrypted user data for a requesting entity (210). As described above, the user data can include a username, e-mail address, phone number, full name, residential address, and/or other appropriate data. The user data can be encrypted using an encryption key obtained from a key coordinator. For example, the encryption key can be a public key that corresponds to a private key that can be used to decrypt the encrypted user data.

The surrogate ID generator 134 obtains parts of keys from key coordinators (220). For example, the surrogate ID generator can obtain from multiple key coordinators 140, respective parts of a first key and respective parts of a second key. The first key can be a decryption key (e.g., private key) for decrypting the encrypted user data. For example, the first key can be the private key corresponding to the public key used to encrypt the user data. The second key can be a private key for use in generating the surrogate ID for the user.

The surrogate ID generator 134 can request a part of the first key and a part of the second key from each of the multiple key coordinators 140. As described above, the request sent to each key coordinator 140 can include the binary of the surrogate ID generator 134. Each key coordinator can verify the binary (e.g., by ensuring that it matches a trusted binary of the surrogate ID generator 134) before sending the parts of the keys to the surrogate ID generator 134. If the binary is verified successfully, the key coordinator can obtain the parts of the keys from its TEE and send the parts of the keys to the surrogate ID generator 134.

The surrogate ID generator 134 generates the first key using the respective parts of the first key received from the multiple key coordinators (230). The surrogate ID generator 134 can combine the parts of the first key to obtain the first key. Example techniques for combing parts of a key to obtain a key are described in U.S. Patent Application No. 18/573,384, titled “SECURE ENVIRONMENT FOR OPERATIONS ON PRIVATE DATA,” filed on Feb. 15, 2023, which is incorporated herein by reference.

The surrogate ID generator 134 generates the second key using the respective parts of the second key received from the multiple key coordinators (240). The surrogate ID generator 134 can combine the parts of the second key to obtain the second key.

The surrogate ID generator 134 decrypts the encrypted user data using the first key to obtain user data in cleartext (250).

The surrogate ID generator 134 generates a surrogate ID using the user data and the second key (260). The surrogate ID generator 134 can generate the surrogate ID by applying a cryptographic hash function to the cleartext user data and the second key. In some implementations, the surrogate ID generator 134 can generate the surrogate ID by applying a cryptographic hash function to the cleartext user data, the second key, and additional information.

The surrogate ID generator 134 sends the surrogate ID to the requesting entity (270). The surrogate ID generator 134 can send the surrogate ID directly to the requesting entity, e.g., over a network, or by way of a surrogate ID staging service 110.

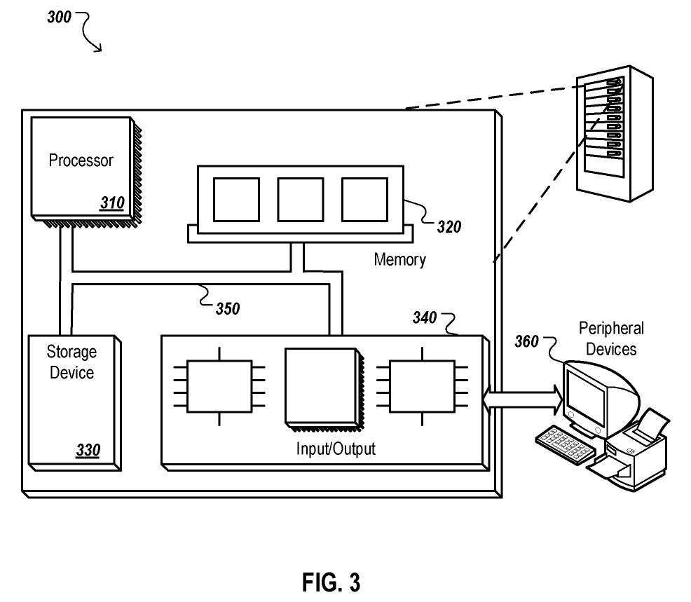

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user’s social network, social actions or activities, a user’s preferences, or a user’s current location). In addition, certain data may be treated in one or more ways before it is stored or used, so that personally identifiable information associated with the user is removed. For example, a user’s identity may be anonymized so that the no personally identifiable information can be determined for the user, or a user’s geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by a surrogate identifier (ID) system, encrypted user data for a requesting entity;
obtaining, by a surrogate ID generator running in a first trusted execution environment (TEE) of the surrogate ID system and from multiple key coordinators respective parts of a first key and respective parts of a second key;
generating the first key using the respective parts of the first key received from the multiple key coordinators;
generating the second key using the respective parts of the second key received from the multiple key coordinators;
decrypting, by the surrogate ID generator, the encrypted user data using the first key to obtain user data in cleartext;
generating, by the surrogate ID generator, a surrogate ID using the user data and the second key; and
sending the surrogate ID to the requesting entity.

2. The computer-implemented method of claim 1, wherein each key coordinator comprises a respective second TEE for storing parts of keys.

3. The computer-implemented method of claim 1, wherein the first key is a first private key, and the second key is a second private key.

4. The computer-implemented method of claim 3, wherein the encrypted user data is generated by encrypting the user data using a first public key corresponding to the first private key.

5. The computer-implemented method of claim 1, wherein generating, by the surrogate ID generator, the surrogate ID using the user data and the second key comprises generating the surrogate ID based on the user data and additional data related to the requesting entity.

6. The computer-implemented method of claim 1, wherein generating, by the surrogate ID generator, the surrogate ID using the user data and the second key comprises applying a cryptographic hash function to the user data and the second key.

7. The computer-implemented method of claim 1, wherein the surrogate ID system is operated by a first entity and each key coordinator is operated by a respective second entity different from each other and different from the first entity.

8. The computer-implemented method of claim 1, wherein obtaining, by the surrogate ID generator running in the first TEE of the surrogate ID system and from multiple key coordinators respective parts of the first key and respective parts of the second key comprises:
sending, to each key coordinator, a request comprising the binary of the surrogate ID generator; and
receiving, from each key coordinator, the respective part of the first key and the respective part of the second key of the key coordinator in response to the key coordinator verifying the binary.

9. The computer-implemented method of claim 1, wherein the surrogate ID generator is stateless.

10. A surrogate identifier (ID) system comprising:
one or more processors comprising a first trusted execution environment (TEE); and
one or more storage devices storing instructions that, when executed by the one or more processors, cause the one or more processors to perform operations comprising:
receiving, by the surrogate ID system, encrypted user data for a requesting entity;
obtaining, by a surrogate ID generator running in a first trusted execution environment (TEE) of the surrogate ID system and from multiple key coordinators respective parts of a first key and respective parts of a second key;
generating the first key using the respective parts of the first key received from the multiple key coordinators;
generating the second key using the respective parts of the second key received from the multiple key coordinators;
decrypting, by the surrogate ID generator, the encrypted user data using the first key to obtain user data in cleartext;
generating, by the surrogate ID generator, a surrogate ID using the user data and the second key; and
sending the surrogate ID to the requesting entity.

11. The surrogate ID system of claim 10, wherein each key coordinator comprises a respective second TEE for storing parts of keys.

12. The surrogate ID system of claim 10, wherein the first key is a first private key, and the second key is a second private key.

13. The surrogate ID system of claim 12, wherein the encrypted user data is generated by encrypting the user data using a first public key corresponding to the first private key.

14. The surrogate ID system of claim 10, wherein generating, by the surrogate ID generator, the surrogate ID using the user data and the second key comprises generating the surrogate ID based on the user data and additional data related to the requesting entity.

15. The surrogate ID system of claim 10, wherein generating, by the surrogate ID generator, the surrogate ID using the user data and the second key comprises applying a cryptographic hash function to the user data and the second key.

16. The surrogate ID system of claim 10, wherein the surrogate ID system is operated by a first entity and each key coordinator is operated by a respective second entity different from each other and different from the first entity.

17. The surrogate ID system of claim 10, wherein obtaining, by the surrogate ID generator running in the first TEE of the surrogate ID system and from multiple key coordinators respective parts of the first key and respective parts of the second key comprises:
sending, to each key coordinator, a request comprising the binary of the surrogate ID generator; and
receiving, from each key coordinator, the respective part of the first key and the respective part of the second key of the key coordinator in response to the key coordinator verifying the binary.

18. The surrogate ID system of claim 10, wherein the surrogate ID generator is stateless.

19. A non-transitory computer readable storage medium carrying instructions that, when executed by one or more processors, cause the one or more processors to perform operations comprising:
receiving, by a surrogate identifier (ID) system, encrypted user data for a requesting entity;
obtaining, by a surrogate ID generator running in a first trusted execution environment (TEE) of the surrogate ID system and from multiple key coordinators respective parts of a first key and respective parts of a second key;
generating the first key using the respective parts of the first key received from the multiple key coordinators;
generating the second key using the respective parts of the second key received from the multiple key coordinators;
decrypting, by the surrogate ID generator, the encrypted user data using the first key to obtain user data in cleartext;
generating, by the surrogate ID generator, a surrogate ID using the user data and the second key; and
sending the surrogate ID to the requesting entity.

20. The non-transitory computer readable storage medium of claim 19, wherein each key coordinator comprises a respective second TEE for storing parts of keys.
